(19) United States
(12) Patent Application Publication
(10) Pub. No.: US 2008/0169664 A1
(43) Pub. Date: Jul. 17, 2008

(54) Decorative accessory for automotive wiper arms

(76) Inventors: Karen L. Dampier, Lawrenceville, GA (US); Franklin Dean Dampier, Lawrenceville, GA (US)

Correspondence Address: JAMES RAY & ASSOCIATES, 2640 PITCAIRN ROAD, MONROEVILLE, PA, 15146, US

(21) Appl. No.: 12/004,794

(22) Filed: Dec. 21, 2007

Related U.S. Application Data
(60) Provisional application No. 60/882,337, filed on Dec. 28, 2006.

(51) Int. Cl. B60J 1/20; B60S 1/04

(52) U.S. Cl. 296/1.07; 15/250.451

(57) ABSTRACT

A decorative accessory for automotive wiper arms. The accessory includes a weather resistant member manufactured from a predetermined material, and having a predetermined shape and a predetermined size. At least one securing means is operably connected to such weather resistant member for securing such weather resistant member to such automotive wiper arm.

### CROSS REFERENCE TO RELATED APPLICATION

This patent application is related to and claims priority from U.S. Provisional Patent Application Ser. No. 60/882,337 filed Dec. 28, 2006.

### FIELD OF THE INVENTION

The present invention relates, in general, to accessories for automobiles and, more particularly, this invention relates to decorative accessories for attachment to automotive wiper arms.

### BACKGROUND OF THE INVENTION

Prior to the conception and development of the present invention, accessories for decorating automobiles are generally well known in the prior art. Automobile owners decorate their cars with magnets, bumper stickers, hood ornaments and the like, however there are no accessories attachable to the wiper arms of an automobile.

### SUMMARY OF THE INVENTION

The present invention provides a decorative accessory for automotive wiper arms. A weather resistant member is manufactured from a predetermined material, and has a predetermined shape and a predetermined size. At least one securing means is operably connected to such weather resistant member for securing such weather resistant member to an automotive wiper arm.

### OBJECTS OF THE INVENTION

It is, therefore, one of the primary objects of the present invention to provide an accessory for attachment to the front or rear windshield wiper arms of an automobile which is easy to attach and detach.

Another object of the present invention is to provide an accessory for attachment to the front or rear windshield wiper arms of an automobile which allows a user to promote or display affection to certain affiliations such as a sporting team, school, city, state, ethnicity, occupation and the like.

Still another object of the present invention is to provide an accessory for attachment to the front or rear windshield wiper arms of an automobile which could include symbols, letters, pictoral design, and a combination thereof thereby allowing a user to express his or her affiliations or to personalize the automobile.

In addition to the various objects and advantages of the present invention described with some degree of specificity above it should be obvious that additional objects and advantages of the present invention will become more readily apparent to those persons who are skilled in the relevant art from the following more detailed description of the invention, particularly, when such description is taken in conjunction with the attached drawing figures and with the appended claims.

### BRIEF DESCRIPTION OF THE DRAWINGS

FIG. 1 is a partial perspective view of a decorative accessory for automotive wiper arms.

FIG. 2 is a partial perspective view of a decorative accessory for automotive wiper arms showing a clamp with a threaded connection.

FIG. 3 is a cross-sectional view of a decorative accessory for automotive wiper arms showing a clamp with a threaded connection along line III-III.

FIG. 4 is a partial perspective view of a decorative accessory for automotive wiper arms showing a clamp with a press fit.

FIG. 5 is cross-sectional view of a decorative accessory for automotive wiper arms showing a clamp with a press fit along line V-V.

### BRIEF DESCRIPTION OF A PRESENTLY PREFERRED AND VARIOUS ALTERNATIVE EMBODIMENTS OF THE INVENTION

Prior to proceeding to the more detailed description of the present invention it should be noted that, for the sake of clarity and understanding, identical components which have identical functions have been identified with identical reference numerals throughout the several views illustrated in the drawing figures.

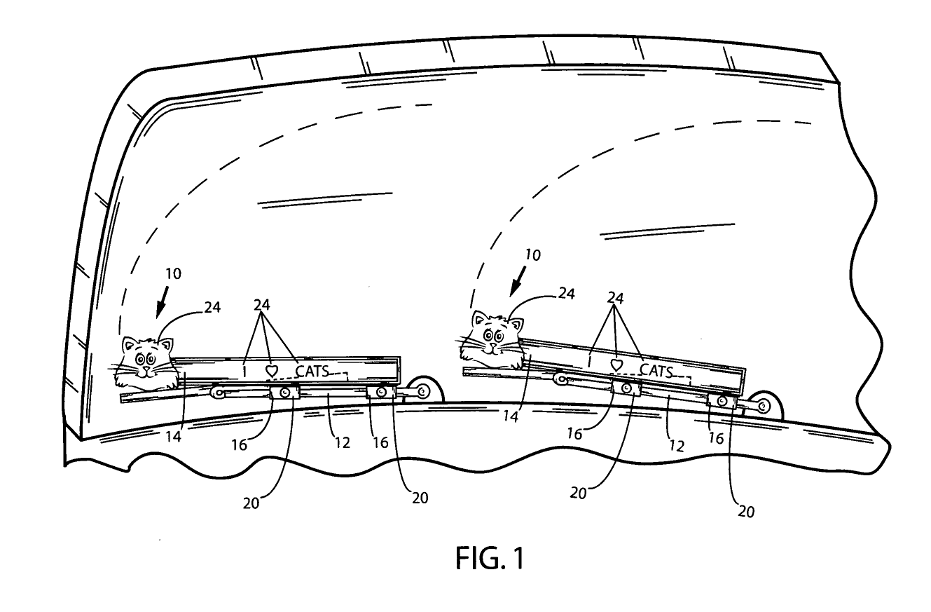

Reference is now made, more particularly, to FIGS. 1-5. A decorative accessory, generally designated 10, for automotive wiper arms 12 is provided. A weather resistant member 14 is manufactured from a predetermined material and has a predetermined shape and a predetermined size. It is presently preferred that the predetermined material is selected from the group consisting of metal, glass, plastic and a combination thereof. It is presently most preferred that such predetermined material is plastic.

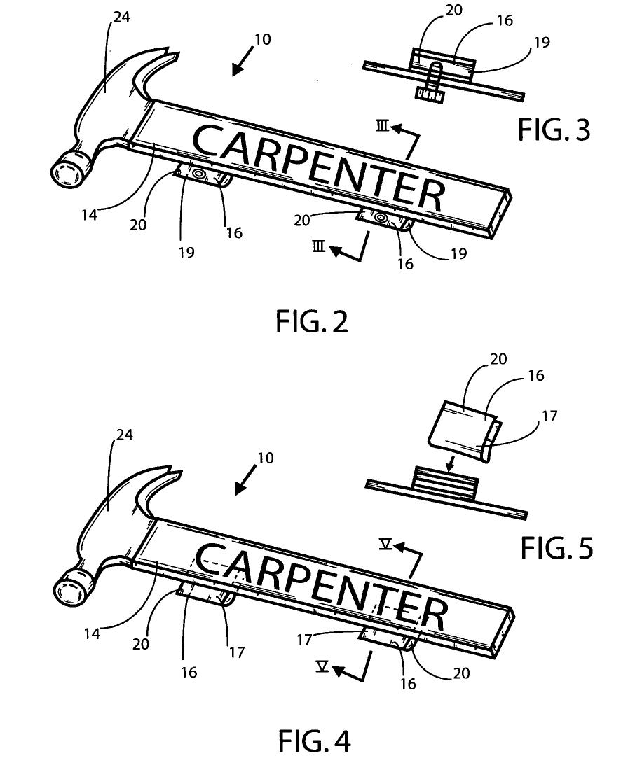

At least one securing means 16 is operably connected to such weather resistant member 14 for securing such weather resistant member 14 to an automotive wiper arm 12. It is presently preferred that such at least one securing means 16 is at least one clamp 20 having at least one of a press fit 17 and a threaded connection 19. It is presently most preferred that such at least one clamp has a threaded connection as illustrated in FIG. 2 and FIG. 3. It is presently most preferred that such at least one clamp 20 is metal.

It is presently preferred that such weather resistant member 14 includes at least one of symbols, letters, pictoral designs, and a combination thereof. It is further presently preferred that such weather resistant member 14 includes indicia, generally designated 24, formed on such weather resistant member 14 illustrating predetermined information relating to predetermined subject matter. It is presently most preferred that such predetermined subject matter relates to at least one of sports teams, school affiliations, business affiliations, religious affiliations and hobbies.

While a presently preferred and various alternative embodiments of the present invention have been described in sufficient detail above to enable a person skilled in the relevant art to make and use the same it should be obvious that various other adaptations and modifications can be envisioned by those persons skilled in such art without departing from either the spirit of the invention or the scope of the appended claims.

We claim:

1. A decorative accessory for automotive wiper arms comprising;
a. a weather resistant member manufactured from a predetermined material, and having a predetermined shape and a predetermined size; and
b. at least one securing means operably connected to said weather resistant member for securing said weather resistant member to an automotive wiper arm.

2. An accessory for automotive wiper arms according to claim 1 wherein said predetermined material is selected from the group consisting of metal, glass, plastic, and a combination thereof.

3. An accessory for automotive wiper arms according to claim 2 wherein said predetermined material is plastic.

4. An accessory for automotive wiper arms according to claim 1 wherein said at least one securing means is at least one clamp having at least one of a press fit and a threaded connection.

5. An accessory for automotive wiper arms according to claim 4 wherein said at least one clamp is metal.

6. An accessory for automotive wiper arms according to claim 1 wherein said weather resistant member includes at least one of symbols, letters, pictoral designs, and a combination thereof.

7. An accessory for automotive wiper arms according to claim 1 wherein said weather resistant member includes indicia formed on said weather resistant member illustrating predetermined information relating to predetermined subject matter.

8. An accessory for automotive wiper devices according to claim 7 wherein said predetermined subject matter relates to at least one of sports teams, school affiliations, business affiliations, religious affiliations and hobbies.
